(19) United States
(12) Patent Application Publication
(10) Pub. No.: US 2012/0305323 A1
(43) Pub. Date: Dec. 6, 2012

(54) DEVICE FOR ATTACHING AN ELECTRIC BATTERY TO THE CHASSIS OF A MOTOR VEHICLE

(75) Inventors: Daniel Baboy, Arthemonay (FR); Franck Jousse, Saint Ouen En Belin (FR); Serge Renouard, Romans sur Isere (FR)

(73) Assignee: RENAULT s.a.s, Boulogne Billancourt (FR)

(21) Appl. No.: 13/517,205

(22) PCT Filed: Nov. 22, 2010
(86) PCT No.: PCT/FR2010/052475

§ 371 Date: Aug. 15, 2012

(30) Foreign Application Priority Data
Dec. 21, 2009 (FR) 0959271

(51) Int. Cl. B60R 16/04; B23P 19/04; H01M 2/02; B23P 11/02

(52) U.S. Cl. 180/68.5; 29/426.6; 29/450; 29/244; 429/163

(57) ABSTRACT

A device for attaching an electric battery to a chassis of a motor vehicle, and including a first quarter-turn attachment mechanism to be rigidly connected to the chassis of the motor vehicle, and a second quarter-turn attachment mechanism to be rigidly connected to the electrical battery, the first and second quarter-turn attachment mechanisms being configured to engage to attach the electric battery to the chassis of the motor vehicle.

The present invention relates to a method for fixing a battery to a motor vehicle and to a method for removing the battery from the motor vehicle. It also relates to a chassis of a motor vehicle having means capable of applying the methods. It also relates to an electric battery having means suitable for the application of the method of the methods. It relates equally to a device having means suitable for applying the methods. It relates finally to an assembly, such as a motor vehicle, comprising such a chassis and/or such an electric battery. It also relates to a tool for mounting an electric battery on a chassis and to a tool for removing an electric battery from a chassis.

Certain motor vehicles, such as electric or hybrid vehicles, comprise a battery for powering an electric drive motor. Because of the ranges of these vehicles, it may be of value to exchange this battery, for a new battery full of energy, when the energy level of the first is low. This can be done in a station similar to a service station in which it is possible to fill a gasoline tank of a motor vehicle.

From document JP 2000 85375, a device is known for fixing an electric battery for powering a motor for driving an electric vehicle to a chassis of this electric vehicle.

From document U.S. Pat. No. 5,612,606, a station is known for exchanging an electric battery for powering a motor for driving an electric vehicle and a method for carrying out such an exchange.

From document WO 2008/128991, a system is known for fixing a battery of a motor vehicle, comprising a quarter-turn fixing means on the battery that comprises a lock that is to be positioned in a hole of the vehicle and then turned a quarter turn in order to fix the battery to the vehicle.

Since the operation to exchange a battery must be carried out in a limited time, there is a need for a device for fixing a battery to a motor vehicle that is simple, robust, reliable, low-cost and that requires no complex toolage in order to remove and reinstall the battery.

Therefore, the object of the invention is to supply a method for fixing a battery to a vehicle and a method for removing the battery from the vehicle that are compatible with the requirements mentioned above. In particular, the invention proposes a fixing/removal method that is simple, reliable and robust allowing removals and reinstallations of the battery that are easy and rapid.

According to the invention, the device for fixing a removable electric battery to a chassis of a motor vehicle is characterized in that it comprises a first quarter-turn fixing means designed to be secured to the chassis of the motor vehicle and a second quarter-turn fixing means designed to be secured to the electric battery, the first and second quarter-turn fixing means being designed to interact in order to fix the electric battery to the chassis of the motor vehicle.

The first fixing means may comprise a spindle designed to be secured to the chassis of the motor vehicle, notably a spindle comprising flats and/or notches.

This feature makes it possible to ensure that the function of coupling the battery is essentially carried out by the vehicle, which reduces the cost of manufacture of the batteries, at the expense of a slight increase in the cost of manufacture of the vehicle, which is however preferable for a manufacturer of electric vehicles when the batteries of these vehicles are also managed by it.

The first fixing means may comprise a force-absorbing means. This force-absorbing means makes it possible to lock an electric battery, of several hundreds of kilograms, on to an electric vehicle, without the latter being raised or the user feeling a considerable jolt, when the battery is positioned beneath the vehicle for locking. Specifically, a very considerable stress must be exerted on the chassis of the vehicle in order to be able to lock the battery.

The second fixing means may comprise a locking element designed to be mounted so as to be able to rotate relative to the battery and designed to interact with the first fixing means.

The locking element may comprise an elongate, for example rectangular or oblong, opening.

The locking element may be mounted so as to be able to rotate on a bell element designed to be secured to the battery.

The first fixing means and/or the second fixing means may comprise an elastic means designed to exert a force returning the first and second fixing means and/or the chassis and the battery to a relative position of rest. This elastic means consists, for example, of rubber pads, cheaper than the use of “Belleville” washers.

According to the invention, the chassis of a motor vehicle is characterized in that it comprises a first quarter-turn fixing means designed to interact with a second quarter-turn fixing means provided on an electric battery in order to fix the electric battery to the chassis of the motor vehicle.

The first fixing means may comprise a spindle secured to the chassis of the motor vehicle.

The first fixing means may comprise an elastic means designed to exert a force returning the first and second fixing means and/or the chassis and the battery to a relative position of rest.

According to the invention, the electric battery for powering an electric motor for driving a motor vehicle is characterized in that it comprises a second quarter-turn fixing means designed to interact with a first quarter-turn fixing means in order to fix the electric battery to the chassis of the motor vehicle.

The second fixing means may comprise a locking element mounted so as to be able to rotate relative to the battery and designed to interact with the first fixing means.

The locking element may be mounted so as to be able to rotate on a bell element secured to the battery.

The second fixing means may comprise an elastic means designed to exert a force returning the first and second fixing means and/or the chassis and the battery to a relative position of rest.

According to the invention, the method of removing an electric battery from a chassis of a motor vehicle is characterized in that it comprises the following steps:
supplying the electric battery and the chassis, an elastic element being interposed between them and exerting a return force and a locking element immobilizing, in a position of the electric battery relative to the chassis in which the elastic means is deformed, the movement of the electric battery relative to the chassis under the effect of the return force,
exerting a force to bring the electric battery and the chassis closer together, the closing force deforming the elastic means and the elastic means exerting a return force opposite to the closing force,
moving, by rotation of at least substantially one quarter turn, the locking element.

The closing force for bringing the electric battery closer to the chassis may be absorbed by an element of a tool in mechanical connection with the chassis.

According to the invention, the method for fixing an electric battery to a chassis of a motor vehicle is characterized in that it comprises the following steps:
supplying the electric battery and supplying the chassis while interposing between them an elastic means,
exerting a force to bring the electric battery and the chassis closer together, the closing force deforming the elastic means and the elastic means exerting a return force opposite to the closing force,
moving, by rotating by at least substantially a quarter turn, the locking element immobilizing, in a position of the electric battery relative to the chassis in which the elastic means is deformed, the movement of the electric battery relative to the chassis under the effect of the return force.

The closing force for bringing the electric battery closer to the chassis may be absorbed by an element of a tool in mechanical connection with the chassis.

According to the invention, the assembly, in particular a motor vehicle and notably an electric motor vehicle, comprises an electric battery defined above and a chassis defined above.

According to the invention, the tool for fixing and/or removing an electric battery defined above relative to a chassis defined above is characterized in that it comprises a means for applying a force for bringing the electric battery and the chassis closer together and/or a means for moving a locking element and/or a means for absorbing the force for bringing the electric battery and the chassis closer together.

The electric battery, the chassis, the methods, the assembly and the fixing tool according to the invention have advantages similar to those of the device according to the invention as explained above.

The appended drawing represents, as an example, one embodiment of a removal method according to the invention and means, notably a removable fixing device, an electric battery, a chassis of a motor vehicle, making it possible to apply such a method.

FIGS. 1, 3, 4, 6, 7 8, 9 and 10 are schematic views illustrating the main steps of one embodiment of the removal method according to the invention.

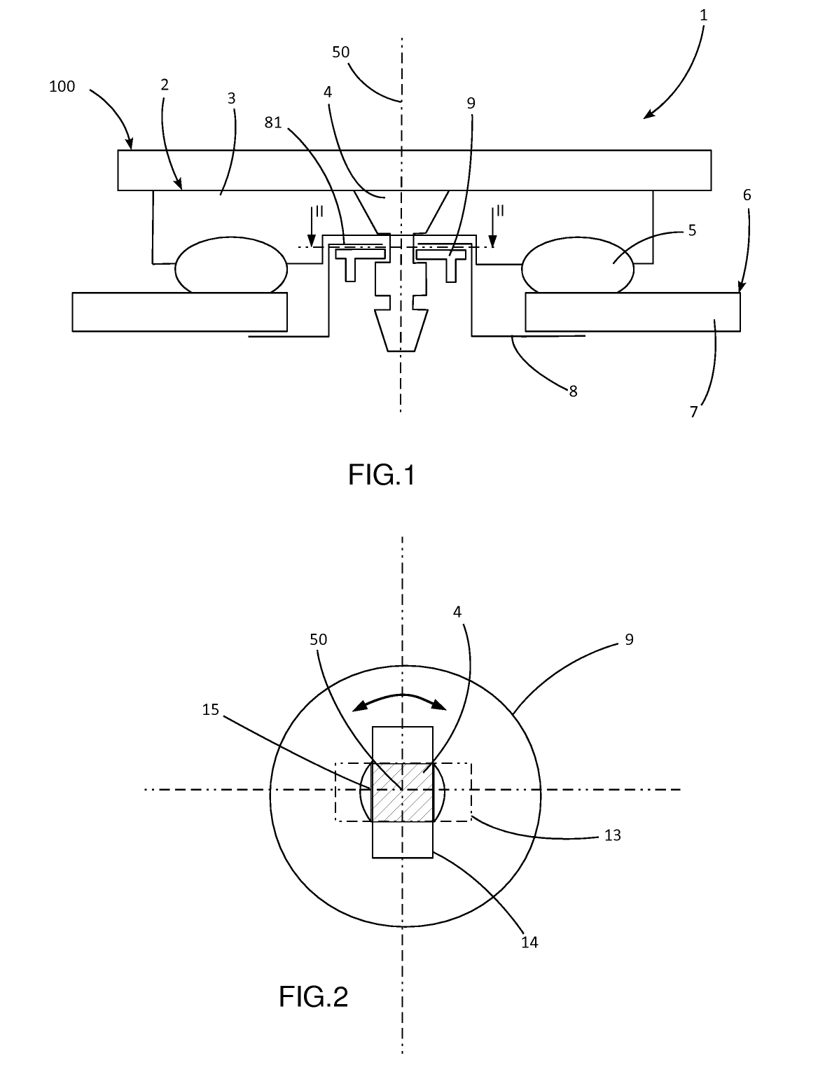

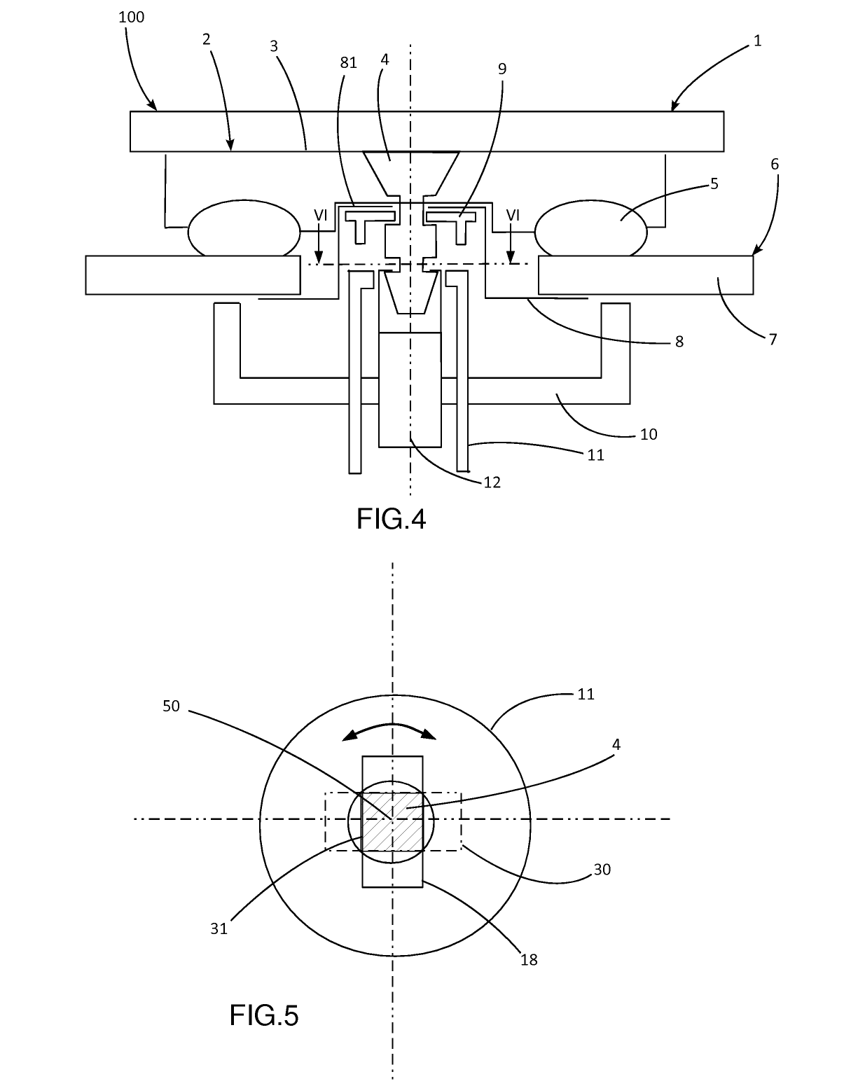

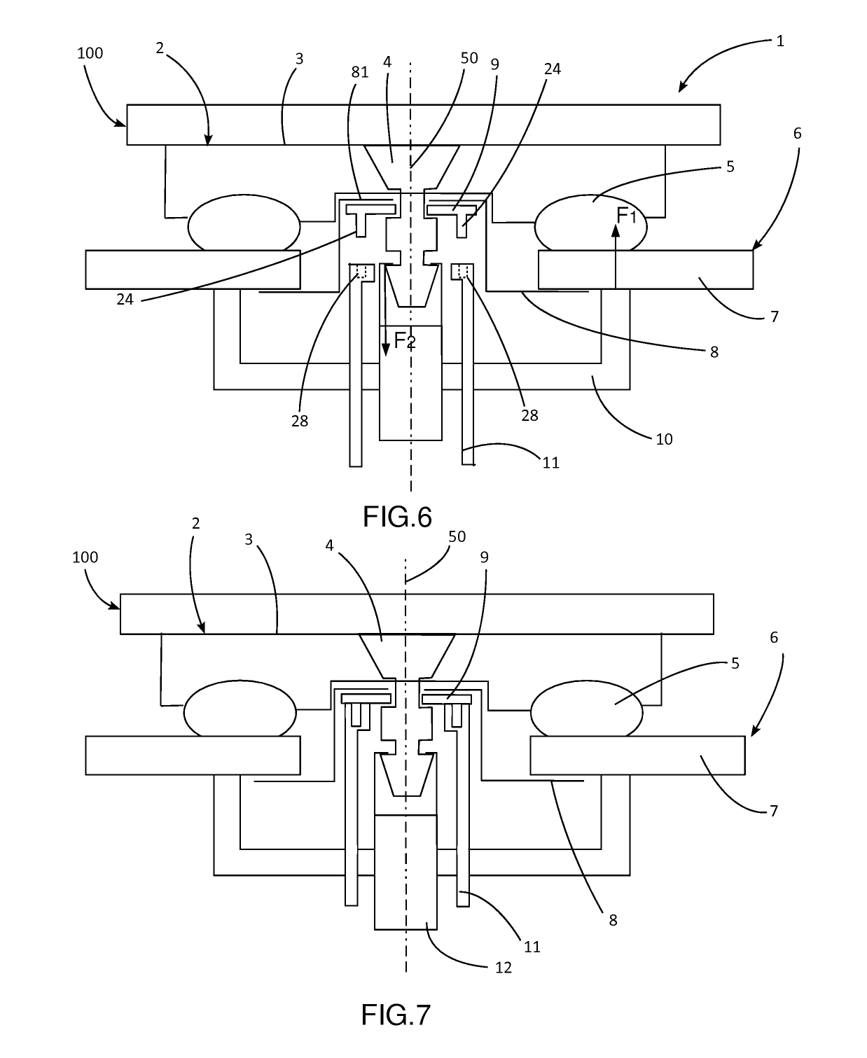

FIGS. 2 and 5 are views in cross section of a fixing device according to the invention.

FIG. 11 is a view in longitudinal section of a first variant of a battery support.

FIG. 12 is a view from above of a battery according to the invention.

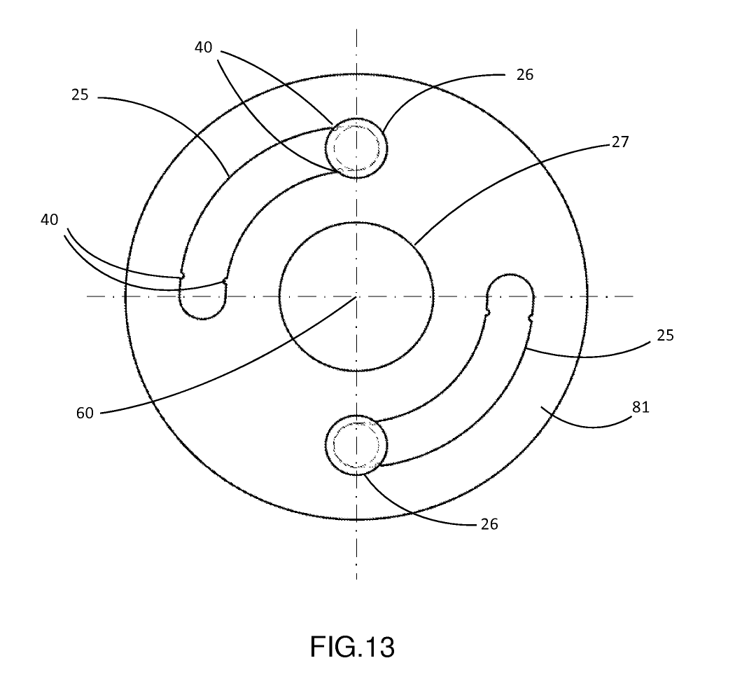

FIG. 13 is a view from above of a bell element and of a battery locking element according to the first variant.

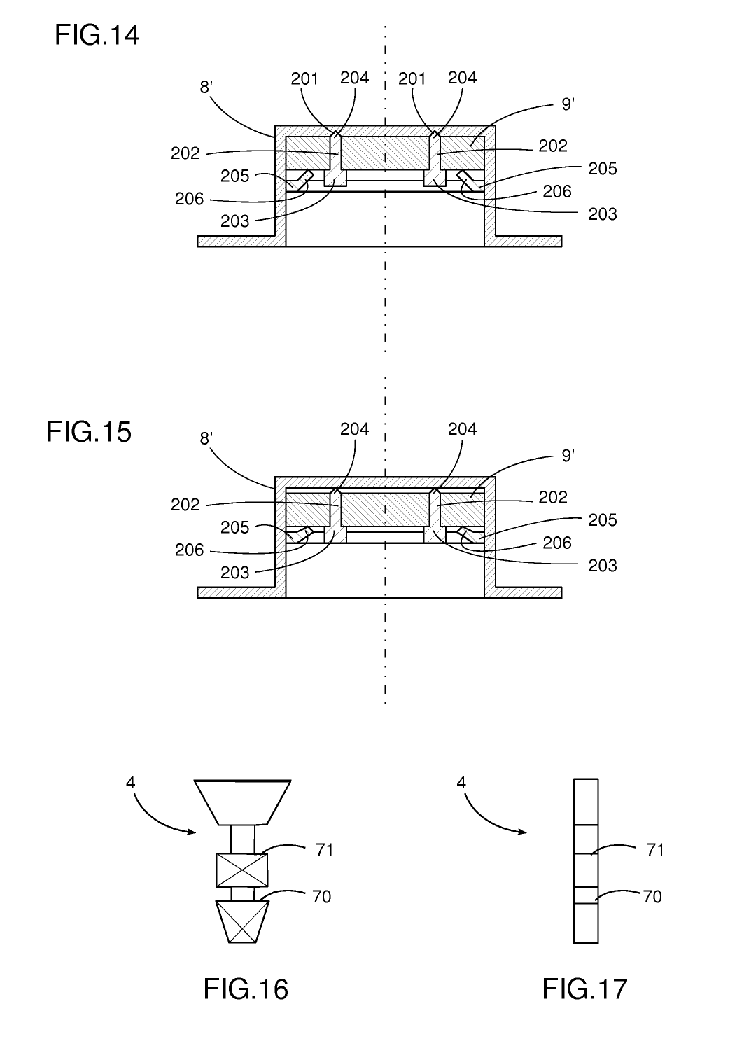

FIGS. 14 and 15 are views in longitudinal section of a second variant of a battery support in two different configurations.

FIGS. 16 and 17 are side views of a spindle used in the fixing device according to the invention.

In the following description, “elastic means” means any means deforming elastically under the effect of a force.

“Quarter-turn fixing” means any fixing means of which two parts can be assembled removably by a first translation action of one of the parts relative to the other, then by a rotary action of one of the parts relative to the other, preferably a rotation by a quarter of a turn. The rotary action may nevertheless have an amplitude other than a quarter of a turn, notably a half-turn or three-quarters of a turn.

“At least substantially a quarter turn” means “a quarter turn” or “substantially a quarter turn”.

The motor vehicle 100 shown partially in FIGS. 1, 3, 4, 6, 7, 8, 9, 10 comprises mainly a chassis 2 and a support 6 for an electric battery (not shown), notably an electric battery for powering a motor for driving the motor vehicle.

The electric battery is designed to be fixed to the chassis. For example, the battery may be fixed under the chassis. It may be installed in a housing that can be accessed from under the chassis of the motor vehicle. Then, after the battery has been placed in its housing, a bottom portion of the battery remains accessible from under the vehicle, notably from under the chassis.

The motor vehicle 100 comprises in particular a device 1 for the removable fixing of a battery support 6 to the chassis 2 of the motor vehicle. The electric energy storage element of the battery is secured to the support 6. The removable fixing device comprises a first quarter-turn fixing means 4 provided on the chassis of the motor vehicle and a second quarter-turn fixing means 8, 9 provided on the electric battery. The first and second quarter-turn fixing means are designed to interact in order to fix the electric battery to the chassis of the motor vehicle.

The first quarter-turn fixing means comprises for example a spindle 4 having an axis 50 and being secured to the chassis 2 of the motor vehicle, in particular secured to a plate 3 fixed to the chassis. Preferably, this spindle comprises a first section 15 of square or circular shape at the sectional plane II-II of FIG. 1 and a second section of rectangular shape under this plane. Other section shapes are possible to ensure the quarter-turn fixing that is described in greater detail below. One particular embodiment is shown in FIGS. 16 and 17. In this embodiment, the spindle comprises a means 70 as a first shoulder in order to absorb the forces applied by a tool on the battery or on a support secured to the battery during mounting and removal. The spindle also comprises a means 71 as a second shoulder for interacting with the second fixing means. Preferably, this spindle has a generally cylindrical shape on which two flats (visible in FIG. 16, shown by crosses) have been produced symmetrically.

The second quarter-turn fixing means comprises a locking element 9 mounted so as to be able to rotate relative to the battery and designed to interact with the first fixing means. Preferably, this locking element is able to rotate relative to the battery about an axis 60 indistinguishable from the axis 50 of the spindle 4 when the battery is installed on the chassis of the motor vehicle. As shown in FIG. 2, the locking element may be made by virtue of a washer having an opening 14 in which the first section 15 of the spindle 4 can turn about the axis 50 and in which the second section 13 of the spindle 4 can be moved along the axis 50 without it being able to turn by a given quantity about this axis. In the embodiment shown in FIG. 2, the section of the opening 14 is defined as the combination of a circle and a rectangle. Thus, in this embodiment, the locking element 9 allows, with the spindle 4, the quarter-turn fixing as follows:
the locking element 9 is oriented and moved in a first direction along the axis 50 along a portion of spindle 4 having the second section 13,
once the locking element has reached a portion of spindle having the first section 15, the locking element is rotated about the axis 50 relative to the spindle 4, preferably by at least substantially a quarter turn.

Alternatively, the opening 14 may simply have an elongate, for example rectangular or oblong, shape.

In the latter position of the locking element relative to the spindle, because of the geometry of the second section 13 of the spindle and of the geometry of the section of the opening 14 of the locking element, the locking element cannot be moved in a second direction opposite to the first direction along the axis 50 along the spindle. Specifically, in this position, a shoulder of the spindle butts against the locking element, preventing the axial movement (in the second direction) of the latter relative to the spindle.

In a first variant shown in FIGS. 11 and 13, the locking element 9 is mounted so as to be able to rotate on a bell element 8 secured to a plate 7 and forming with it the battery support. In particular, the locking element can be mounted on the bottom 81 of the bell element. As shown in FIG. 13, advantageously, the bottom of the bell element has grooves 25 making it possible to guide and to limit the movement of the locking element 9 relative to the bell element. These grooves are designed to interact with fingers 26 provided on the locking element and acting on a detection means, for example a switch, making it possible to determine the “unlocked” or “locked” state of the battery on the chassis.

The grooves may also have indexing means 40 for indexing in position, at the ends of the grooves, these extreme positions corresponding to two “locked” and “unlocked” states of the first and second quarter-turn fixing means. The indexing means may for example comprise small bosses 40 in the abovementioned grooves. Alternatively, they may comprise bosses and holes provided to interact with one another on opposite faces of the parts 8 and 9.

In a second variant shown in FIGS. 14 and 15, the locking element 9 is mounted so as to be able to rotate in a bell element 8′ secured to the plate 7 and forming with it the battery support 6. Specifically, a segment 205 placed in position in the bell element stops the locking element 9′ from translating. This segment 205 comprises elastic elements 206 resting on the locking element in order to return the latter into contact with the bottom of the bell element. Moreover, the locking element is traversed by one or more pins 202. A first end 203 of a pin allows the rotation of the locking element by a tool and a second end 204 of a pin allows the indexing in position of the locking element relative to the bell element. This second end is formed as a boss constituting a protrusion on the face of the locking element coming to the bottom of the bell element. This second end formed as a boss interacts with one or more holes 201, notably one or more blind holes, provided in the bottom of the bell element. The pins and the holes constitute indexing means. In FIG. 14, the locking element and the bell element are shown in an indexed position, two ends 204 of pins being engaged in the holes made in the bottom of the bell element. In FIG. 15, the locking element and the bell element are shown in an unindexed position, the ends 204 of the pins not being engaged in the holes made in the bottom of the bell element. Thus, in this configuration, the locking element is not pressed against the bottom of the bell element and the abovementioned elastic means 206 are deformed.

In the second variant also, the locking element may have a finger passing through the bottom of the bell element and interacting with a detection means in order to determine the “locked” or “unlocked” configuration of the fixing device. Similarly, means for guiding and/or for limiting the movement of the locking element in the bell element may be provided. The means for guiding and/or for limiting the movement may have a finger secured to the locking element and passing through the bottom of the bell element in a groove.

As shown in FIGS. 11 and 12, the bell element 8 is secured to the plate 7 via a flexible coupling 21, 22. Specifically, the bell element is put in place in an opening 82 made in the plate and comes to rest, by virtue of a shoulder 83, on a first face of the plate. Double-acting elastic elements 29 and/or single-acting elastic elements 29 make it possible to elastically center the bell element in the opening 82 and to press the latter against the first face. Preferably, the elastic elements are fixed to the bell element via spigots 23 fitted in pierced holes made in the bell element. The double-acting elastic elements 29 comprise first elastic strips 21 resting on the bell element on the one hand, and on walls of the opening on the other hand, in order to ensure an elastic centering and comprise second elastic strips 22 resting on a second face of the plate in order to ensure the elastic placement of the first face of the plate on the shoulder 83. The single-acting elastic elements 29 comprise first elastic strips 21 resting on the bell element on the one hand and on walls of the opening 82 on the other hand in order to ensure an elastic centering. Thus, the bell element may be moved relative to the plate along the longitudinal axis X and transverse axis Y (perpendicular to the axis 50) by a limited amplitude, for example by 5 mm to 10 mm and typically by 6 mm.

Preferably, the removable fixing device comprises an elastic means 5 placed at the chassis-electric battery interface and designed to exert a return force separating the first and second fixing mean and/or the first and second fixing means. For example, the elastic means may comprise one or more posts 5 made of elastomer. Nevertheless any elastic means may be suitable, notably a spring. Although shown secured to the first quarter-turn fixing means and secured to the chassis of the motor vehicle, it is clear that the elastic means may alternatively be secured to the second quarter-turn fixing means and to the battery. Also alternatively, the elastic means may comprise first means secured to the chassis of the motor vehicle and second means secured to the battery. The elastic means make it possible to apply a stress between the chassis and the battery so as to immobilize the latter relative to one another in translation along the axes X and Y by virtue of friction at the battery-chassis interface.

One embodiment of a method for removing a battery from a motor vehicle is described below with reference to FIGS. 1, 3, 4, 5, 6, 7, 8, 9 and 10.

In an initial state, the battery 6 is fixed to the motor vehicle 100.

Its removal or its dismantling is carried out by virtue of a tool comprising three main elements 10, 11, 12.

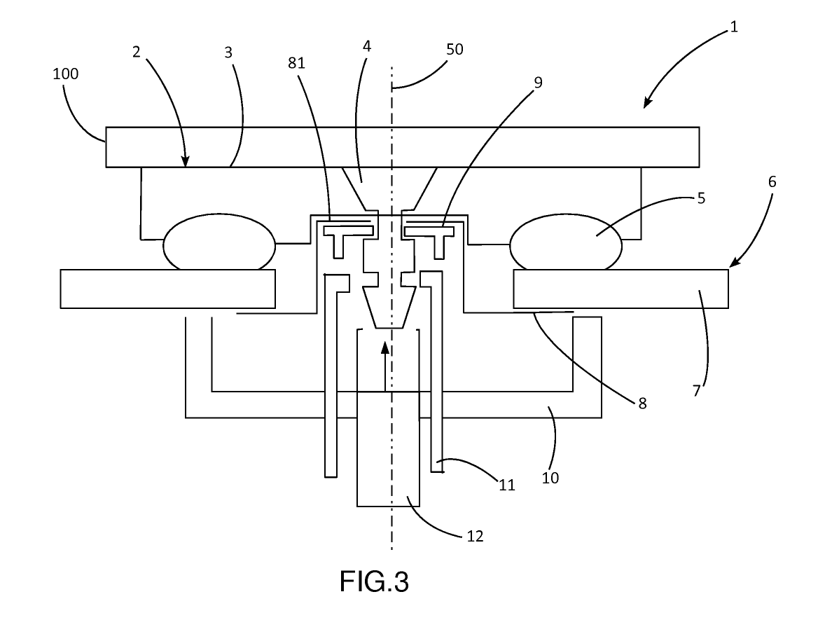

In a first step shown in FIG. 3, the tool is brought up to the battery.

In a second step shown in FIG. 4, the first main element 12 of the tool is coupled first quarter-turn fixing means 4. Preferably, this coupling is carried out also by a quarter-turn connection as shown in FIG. 5. The first main element of the tool comprises a third quarter-turn fixing means designed to interact with the fourth quarter-turn fixing means secured to the chassis. As shown in FIG. 4, the third fixing means has an opening 18 in which a third section 31 of the spindle 4 (for example identical to the first section 15) can turn about the axis 50 and in which a fourth section 30 of the spindle 4 (for example identical to the second section 15) can move in translation along the axis 50 without it being able to turn by a given quantity about this axis. In the embodiment shown in FIG. 4, the section of the opening 18 is defined as the combination of a circle and a rectangle. Thus, in this embodiment, the first main tool element allows with the spindle 4 the quarter-turn fixing as follows:
the first main element 12 of the tool is oriented and moved in a first direction along the axis 50 along a portion of spindle 4 having the fourth section 30,
once the locking element has reached a portion of spindle having the third section 31, the locking element is rotated about the axis 50 relative to the spindle 4, preferably by at least substantially a quarter turn.

The function of the first main element of the tool is to absorb the forces along the axis 50 (in particular the vertical forces directed upward) which will be applied subsequently to the battery and consequently to the motor vehicle so that these forces do not have consequences elsewhere on the motor vehicle.

In a third step shown in FIG. 6, a second main element 10 of the tool is brought into contact with the battery support 6, notably a plate 7 of the battery support or into contact with the battery. The function of this second main element is to exert on the battery a force F1 along the axis 50 (in particular a vertical force directed upward) in order to compress the elastic means 5 and thus remove the contact that exists between the first fixing means and the second fixing means, in particular, remove the contact of the locking element 9 with a shoulder of the spindle 4. The absorption of this force or of a portion of this force is provided, as mentioned above, by the first main element of the tool that exerts a force F2 opposite to the force F1.

In a fourth step shown in FIG. 7, a third main element 11 of the tool is brought into contact with the locking element and, by virtue of this third element, a rotary movement is applied about the axis 50 of the locking element relative to the battery and relative to the first quarter-turn fixing means. Preferably, the rotary movement is at least substantially a rotary movement of a quarter turn. In order to ensure this movement, the third main element of the tool comprises for example holes 28 designed to receive pins 24 provided on the locking element. Thus, the battery is unlocked from the chassis of the vehicle.

In a fifth step shown in FIG. 8, the third main element 11 of the tool is separated from the locking element and moved away from the latter.

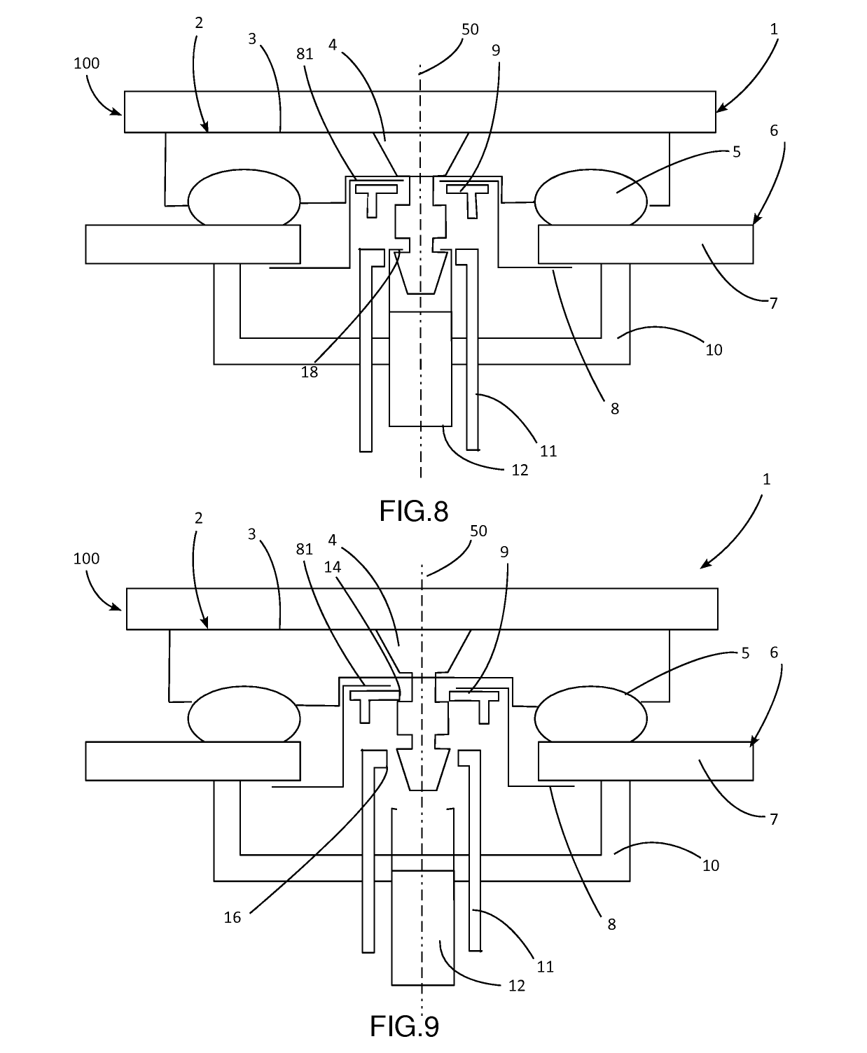

In a sixth step shown in FIG. 9, the first main element 12 of the tool is separated from the first quarter-turn fixing means 4 and moved away from the latter, for example in a translation movement.

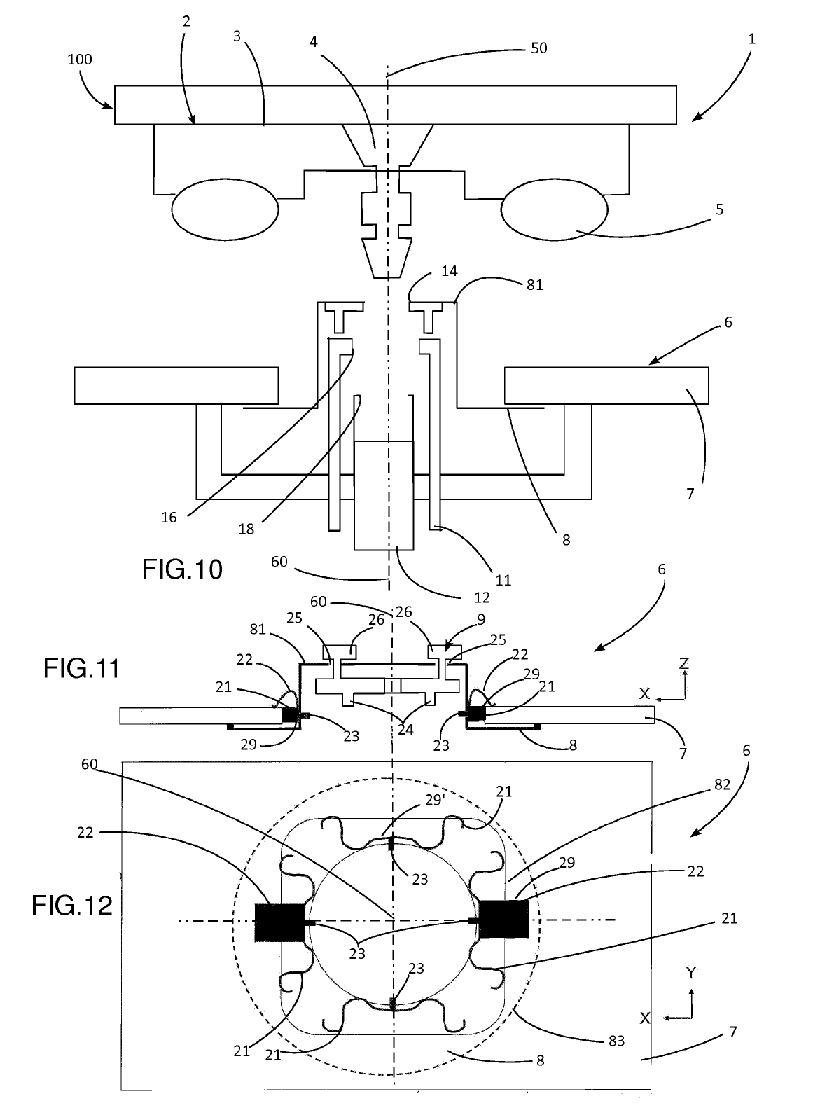

In a seventh step shown in FIG. 10, the second main element 10 of the tool is also moved downward while it holds the battery. Thus, the battery is moved away from the motor vehicle.

The sixth and seventh steps can be carried out simultaneously.

Conversely, one embodiment of a method for mounting or for fixing a battery to a motor vehicle is described below.

In an initial state, the battery is separate from the motor vehicle.

The mounting is carried out by virtue of the tool described above.

In a first step, by virtue of the second main element of the tool, the battery is brought closer to the chassis of the motor vehicle.

In a second step, the first main element 12 of the tool is coupled to the first quarter-turn fixing means 4 as in the removal method.

In a third step, the second main element 10 of the tool is brought into contact with the battery and the battery is pressed against the chassis of the motor vehicle by exerting thereon, or on a support of the latter, a force F1 along the axis 50 (in particular a vertical force directed upward) in order to compress the elastic means 5. The absorption of this force or of a portion of this force is provided, as mentioned above, by the first main element of the tool which exerts a force F2 opposite to the force F1.

In a fourth step, the third main element 11 of the tool is brought into contact with the locking element and, by virtue of this third element, a rotary movement is applied about the axis 50 of the locking element relative to the battery and relative to the first quarter-turn fixing means. Preferably, the rotary movement is at least substantially a rotary movement of a quarter turn. Thus, the battery is fixed to the chassis of the motor vehicle.

In a fifth step, the third main element of the tool is separated from the locking element and moved away from the latter.

In a sixth step, the force applied by the second main element of the tool on the battery is removed and the first main element of the tool is separated from the first quarter-turn fixing means 4. The first and second main elements of the tool are moved away from the battery.

1-17. (canceled)

18. A device for fixing a removable electric battery to a chassis of a motor vehicle, comprising:
a first quarter-turn fixing means configured to be secured to the chassis of the motor vehicle; and
a second quarter-turn fixing means configured to be secured to the electric battery;
the first and second quarter-turn fixing means being configured to interact to fix the electric battery to the chassis of the motor vehicle,
wherein the first fixing means comprises a spindle configured to be secured to the chassis of the motor vehicle, the spindle comprising flats and/or notches.

19. The device as claimed in claim 18, wherein the first fixing means comprises a force-absorbing means.

20. The device as claimed in claim 18, wherein the second fixing means comprises a locking element configured to be mounted to be able to rotate relative to the battery and to interact with the first fixing means.

21. The device as claimed in claim 20, wherein the locking element comprises an elongate, or rectangular, or oblong opening.

22. The device as claimed in claim 21, wherein the locking element is mounted to be able to rotate on a bell element configured to be secured to the battery.

23. The device as claimed in claim 18, wherein the first fixing means and/or the second fixing means comprises an elastic means configured to exert a force returning the first and second fixing means and/or the chassis and the battery to a relative position of rest.

24. A chassis of a motor vehicle comprising:
a first quarter-turn fixing means configured to interact with a second quarter-turn fixing means provided on an electric battery to fix the electric battery to the chassis of the motor vehicle,
wherein the first fixing means comprises a spindle configured to be secured to the chassis of the motor vehicle, the spindle comprising flats and/or notches.

25. The chassis as claimed in claim 24, wherein the first fixing means comprises an elastic means configured to exert a force returning the first and second fixing means and/or the chassis and the battery to a relative position of rest.

26. An electric battery for powering an electric motor for driving a motor vehicle, comprising:
a second quarter-turn fixing means configured to interact with a first quarter-turn fixing means to fix the electric battery to a chassis of the motor vehicle,
wherein the second quarter-turn fixing means comprises a locking element comprising an elongate opening and configured to be mounted to be able to rotate relative to the battery.

27. The electric battery as claimed in claim 26, wherein the locking element is mounted to be able to rotate on a bell element secured to the battery.

28. The electric battery as claimed in claim 26, wherein the second fixing means comprises an elastic means configured to exert a force returning the first and second fixing means and/or the chassis and the battery to a relative position of rest.

29. A method of removing an electric battery as claimed in claim 26 from a chassis of a motor vehicle, comprising:
supplying the electric battery and the chassis, an elastic element being interposed between them and exerting a return force and locking element immobilizing, in a position of the electric battery relative to the chassis in which the elastic means is deformed, movement of the electric battery relative to the chassis under effect of the return force;
exerting a closing force to bring the electric battery and the chassis closer together, the closing force deforming the elastic means and the elastic means exerting a return force opposite to the closing force; and
moving, by rotation of at least substantially one quarter turn, the locking element.

30. The removal method as claimed in claim 29, wherein the closing force for bringing the electric battery closer to the chassis is absorbed by an element of a tool in mechanical connection with the chassis.

31. A method for fixing an electric battery as claimed in claim 26 to a chassis of a motor vehicle, comprising:
supplying the electric battery and supplying the chassis while interposing between them an elastic means;
exerting a closing force to bring the electric battery and the chassis closer together, the closing force deforming the elastic means and the elastic means exerting a return force opposite to the closing force;
moving, by rotating by at least substantially a quarter turn, the locking element immobilizing, in a position of the electric battery relative to the chassis in which the elastic means is deformed, movement of the electric battery relative to the chassis under effect of the return force.

32. The fixing method as claimed in claim 31, wherein the closing force for bringing the electric battery closer to the chassis is absorbed by an element of a tool in mechanical connection with the chassis.

33. An assembly, or a motor vehicle, or an electric motor vehicle, comprising:
an electric battery as claimed in claim 26.

34. A tool for fixing and/or removing an electric battery as claimed in claim 26 relative to a chassis, comprising:
means for applying a force for bringing the electric battery and the chassis closer together and/or a means for moving a locking element, and/or means for absorbing the force for bringing the electric battery and the chassis closer together.
